(19) United States
(12) Patent Application Publication
(10) Pub. No.: US 2013/0022530 A1
(43) Pub. Date: Jan. 24, 2013

(54) Production Of Exfoliated Graphite

(71) Applicant: Robert Angelo Mercuri, Seven Hills, OH (US)

(72) Inventor: Robert Angelo Mercuri, Seven Hills, OH (US)

(21) Appl. No.: 13/186,131

(22) Filed: Jul. 19, 2011

(51) Int. Cl. D01F 9/12; C01B 31/04; B82Y 40/00

(52) U.S. Cl. 423/447.1; 423/448; 977/842

(57) ABSTRACT

A process for the production of exfoliated graphite is presented, involving providing a graphite intercalation compound; and exfoliating the graphite intercalation compound by passing the graphite intercalation compound through a plasma which is at a temperature of at least about 6000° C. to bring the graphite intercalation compound to a temperature between about 1600° C. and about 3400° C.

### RELATED APPLICATIONS

The present application claims priority under 35 U.S.C. §120 from copending and commonly assigned U.S. patent application Ser. No. 12/794,872, entitled Production of Nano-Structures, filed in the name of Robert A. Mercuri on Jun. 7, 2010 and from copending and commonly assigned U.S. patent application Ser. No. 12/794,882, entitled Production of Nano-Structures, filed in the name of Robert A. Mercuri on Jun. 7, 2010, the disclosures of each of which are incorporated by reference herein.

### TECHNICAL FIELD

The present disclosure relates to the production of exfoliated graphite, including nano-structures, such as graphene particles, nano-tubes, Buckminster fullerenes (commonly referred to as “buckyballs”), and nano-scale plates. More particularly, the disclosure relates to the production of exfoliated graphite in a process capable of the efficient production of exfoliated graphite, including commercial quantities of nano-structures, using natural graphite starting materials.

### BACKGROUND OF THE DISCLOSURE

Natural graphite is formed of layered planes of hexagonal arrays or networks of carbon atoms, with extremely strong bonds within the layers, and relatively weak bonding between the layers. The carbon atoms in each layer plane (generally referred to as basal planes or graphene layers) are arranged hexagonally such that each carbon atom is covalently bonded to three other carbon atoms, leading to high intra-layer strength. However, the bonds between the layers are weak van der Waals forces (which are less than about 0.4% of the strength of the covalent bonds in the layer plane). Accordingly, because these inter-layer bonds are so weak as compared to the covalent intra-layer bonds, the spacing between layers of the graphite particles can be chemically or electrochemically treated so as to be opened up to provide a substantially expanded particle while maintaining the planar dimensions of the graphene layers.

It is this characteristic of natural graphite which is exploited in the production of sheets of compressed particles of exfoliated graphite, which is used in the production of, inter alia, gasket materials, fuel cell components, electronic thermal management articles and devices, etc. As taught by Shane et al. in U.S. Pat. No. 3,404,061, natural graphite flakes can be intercalated by dispersing the flakes in a solution of a mixture of nitric and sulfuric acids. After intercalation, the flakes can be drained and washed, and are then exposed to temperatures, such as from about 700° C. to about 1000° C., with a high temperature of about 1200° C., which causes the flakes to expand in an accordion-like fashion in the direction perpendicular to the planes of the particle, by an amount that can be greater than 80 times, and as much as about 1000 times or greater, to form what are commonly called “worms.” These worms can then be formed in to sheets, even without the presence of binders, which can be formed, cut, molded and otherwise deformed.

Additional processes for the production of these sheets of compressed particles of exfoliated graphite are taught by, for instance, Mercuri et al. in U.S. Pat. No. 6,432,336, Kaschak et al. in International Publication No. WO 2004/108997, and Smalc et al. in U.S. Pat. No. 6,982,874. The unique directional properties of natural graphite (while graphite is commonly referred to as anisotropic, from a crystallographic standpoint, graphite should more properly be referred to as orthotropic or exhibiting transverse isotropy; in the plane of sheet, it is isotropic in two directions along the plane) provide sheets of compressed particles of exfoliated graphite having directional electrical and thermal characteristics, where conductivity is substantially higher along the plane of the sheet as opposed to through the sheet, is leveraged in the production of thermal management articles and fuel cell components.

The intercalation process described above functions to insert a volatile species between the layer planes of the graphite flake which, when exposed to high temperatures, rapidly volatilizes, causes separation of the layers and, consequently, exfoliation. Typical intercalation of graphite for the production of sheets of compressed particles of exfoliated graphite is Stage VII or greater Stage value. The Stage Index is a measure of the average number of graphene layers between each “gallery” (the space between graphene layers in which the chemical intercalant is inserted), rounded to the nearest whole number. Therefore, in Stage VII intercalation, there are, on average, less than 7.5 graphene layers between each gallery. In Stage VIII intercalation, there are, on average, at least 7.5 graphene layers between each gallery.

The Stage Index of an intercalated graphite flake can be determined empirically by x-ray diffraction to measure the “c” lattice spacing (the spacing between any three graphene layers), where a spacing of 6.708 indicates (\acute{Å}) represents a non-intercalated graphite flake and over 8 \acute{Å} indicates an intercalated flake with Stage I intercalation (on average, only one graphene layer separating each gallery, or as complete intercalation as possible).

Processes for preparing lower intercalation Stages (more specifically, Stage III and lower) are known. For instance, Kaschak et al. (International Publication No. WO 2004/108997) described a process for preparing Stage V (i.e., intercalation between, on average, every fifth graphene layer) or lower intercalation using supercritical fluids. Other systems for preparing intercalated graphite flakes having Stage III or higher degree intercalation (that is, intercalation to Stage I, II or III) using methanol, phosphoric acid, sulfuric acid, or simply water, combined with nitric acid in various combinations, are known, for both “normal” or “spontaneous” intercalation and electrochemical intercalation.

For instance, an admixture of up to 15% water in nitric acid can provide Stage III or II spontaneous intercalation and Stage I electrochemical intercalation; for methanol and phosphoric acid, an admixture of up to 25% in nitric acid can provide Stage II spontaneous intercalation and Stage I electrochemical intercalation. The chemical or electrochemical potential of the intercalant critically effects the thermodynamics of the process, where higher potential leads to a lower stage number (i.e., a greater degree of intercalation), while kinetic effects such as time and temperature combine to define processes which can be of commercial importance.

As noted above, the process of the disclosure can be used to produce exfoliated graphite for the production of nano-structures, such as graphene particles, nano-tubes, Buckminster fullerenes (commonly referred to as “buckyballs”), and nano-scale plates. Nano-structures, especially nano-tubes and buckyballs, have been the subject of extensive research; they have remarkable tensile strength and exhibit varying electrical properties, such as superconducting, insulating, semi-conducting or conducting, depending on their helicity, and are thus utilizable as nanoscale wires and electrical components. The electrical conductivity of nano-structures is as high or higher than copper, thermal conductivity as high as diamond, and the tensile strength of these structures can be 100 times greater than steel, leading to structures that have uses in space, and that are believed to have applications as diverse as the formation of field-effect transistors and nano-motors. Indeed, there are those who believe nano-tubes and other nano-scale structures can be the solution to the hydrogen storage issues bedeviling the nascent hydrogen fuel cell industry, since hydrogen can be adsorbed on their surface. In addition, exfoliated graphite also has use in applications such as conductive inks and the like, water purification and additives for rubber compounds for use in, e.g., tires and the like.

When referring to nano-structures, what is meant is a structure which is, on average, no greater than about 1000 nanometers (nm), e.g., no greater than about one micron, in at least one dimension. Therefore, in the case of a nano-scale plate, the thickness (or through-plane dimension) of the plate should be no greater than about 1000 nm, while the plane of the plate can be more than one millimeter across; such a nano-plate would be said to have an aspect ratio (the ratio of the major, or in-plane, dimension to the minor, or through-plane, dimension) that is extremely high. In the case of a nano-tube, the average internal diameter of the tube should be no greater than about 1000 nm (thus, with a length of up to a millimeter (mm), the aspect ratio of nano-tubes is also extremely large); in the case of a buckyball, the diameter of the buckyball, such as the truncated icosahedron (the shape of a 60-carbon buckyball), should be no greater than about 1000 nm. A minor dimension of the nano-structure (for instance, the thickness of a nano-scale plate or the internal diameter of a nano-tube), should preferably be no greater than about 250 nm, most preferably no greater than about 20 nm.

Unfortunately, the production of commercial-scale quantities of nano-structures is expensive, laborious and time-consuming, to the extent that doing so is not considered feasible. Production processes currently employed include high pressure carbon monoxide conversion (HiPCO), pulsed-laser vaporization (PLV), chemical vapor deposition (CVD) and carbon arc synthesis (CA). None of these processes is considered adequate in the long term.

What is desired, therefore, is a process for preparing exfoliated graphite, which in certain embodiments can also be used for the production of nano-structures, in a cost-effective and commercially feasible manner. In some embodiments, the desired process will enable the production of nano-structures, whether nano-tubes, buckyballs or nano-plates, in quantities sufficient for industry-scale uses without the requirement of exotic equipment, unusual raw materials or extreme process parameters.

### SUMMARY OF THE DISCLOSURE

The present disclosure provides a process for producing exfoliated graphite using graphite intercalation compounds (GICs). GICs are graphite flakes which have been treated with an intercalant under conditions such that a volatile compound is inserted between layer planes of the graphite flake. The intercalation can be spontaneous intercalation or electrochemical intercalation. In certain embodiments, the process uses Stage III or lower GICs (that is, GICs intercalated to Stage I, II or III).

The GICs are then exposed to sufficient heat to cause rapid expansion of the intercalated graphite flakes; in some embodiments, this expansion process is under conditions which cause at least some of the individual graphene layers to separate and thus form nano-structures. In certain embodiments, the process involves feeding the GICs directly into a gas plasma, such as through a plasma torch. A plasma torch (sometimes called a plasma arc or plasma gun) is an apparatus which can generate a directed flow of plasma from a nozzle, and is conventionally used for a number of applications such as plasma cutting, plasma spraying, plasma arc waste disposal (which is used to reduce waste to power generating gas and construction rubble). One suitable plasma torch uses an ionized gas which is then further ionized and coupled to an induction coil, such as a radio frequency (RF) induction coil, to create the plasma, which is at a temperature that can exceed 6000° C.

By passing the GICs through the plasma, the GICs are subjected to high heat flux (i.e., the GICs are rapidly heated), which produces rapid expansion. In this way, the GICs are exfoliated to a substantially greater degree than in conventional processes; in addition, use of the disclosed process can lead to the production of nano-structures in commercial quantities from natural graphite flakes, especially natural graphite flakes which have been intercalated so as to form Stage III or lower GICs. Contrariwise, at lower heat flux, the expansion of the GICs is slower, which can cause the intercalant to be removed with relatively little disruption (i.e., exfoliation) in the direction of the crystal perpendicular to the graphene layer, resulting in lower levels of expansion and little or no production of nano-structures.

Therefore, an aspect of the present disclosure relates to a process for producing exfoliated graphite through exposing graphite intercalation compounds to rapid heating.

Another aspect of the present disclosure relates to a process for producing nano-scale structures, such as nano-tubes, Buckminster fullerenes, nano-plates and the like.

Still another aspect of the disclosure relates to a process for producing nano-scale structures, which is capable of producing commercial quantities of nano-scale structures.

Yet another aspect of the present disclosure relates to an efficient process for producing exfoliated graphite.

Still another aspect of the present disclosure relates to a process for producing nano-scale structures from natural graphite flakes.

Another aspect of the present disclosure relates to a process for producing nano-scale structures from natural graphite flakes in a process which does not require the use of exotic equipment or extreme process parameters.

These aspects of embodiments of the disclosure, and others which will become apparent to the artisan upon review of the following description can be accomplished by providing a process for the production of exfoliated graphite, which includes providing a graphite flake comprising graphene layers and intercalating the graphite flake to form a graphite intercalation compound. In certain embodiments, the graphite intercalation compound exhibits Stage I, II or III intercalation. The graphite intercalation compound is exfoliated by passing it into a plasma to expose the graphite intercalation compound to high temperatures and to raise the temperature of the GIC to a temperature between about 1600° C. and about 3400° C. In some embodiments, a plurality of individual graphene layers are separated from the graphite intercalation compound. In certain of these embodiments, at least some of the plurality of individual graphene layers spontaneously form a nano-tube or a Buckminster fullerene. The graphite intercalation compound is, in certain embodiments, brought from a temperature at which it is stable to a temperature between about 1600° C. and about 3400° C. in less than 0.2 second, more preferably less than 0.1 second, and most preferably less than about 0.05 second.

In some embodiments, the graphite intercalation compound is exfoliated by passing it through a plasma in a plasma torch, where the plasma includes a region where the temperature is at least about 6000° C. In other embodiments, the temperature of the plasma is between about 6000° C. and about 10,000° C., or even higher, such as temperature approaching or in excess of 12,000° C.

The graphite flake is preferably intercalated with an intercalant comprising nitric acid, sulfuric acid, formic acid, acetic acid, water, or combinations thereof. In certain embodiments, the graphite intercalation compound is exposed to a supercritical fluid prior to exfoliation. Exfoliation preferably involves suddenly exposing the graphite intercalation compound to a temperature significantly above the decomposition temperature of the GICs (i.e., about 2500° C.). Most preferably the temperature of exfoliation should exceed 6000° C., or even plasma temperatures as great as about 10,000° C. or higher. As noted, residence time at these temperatures should be less than 0.2 second. It is preferred that exfoliation take place in an inert or protective environment in order to avoid oxidation of the graphite.

In an advantageous embodiment, exfoliation is accomplished by feeding the graphite intercalation compound into an inert gas plasma especially in a reducing gas environment, such as a hydrogen environment. By “inert gas plasma” is meant there is less than 8%, more preferably less than 5% of a reactive gas present.

It is to be understood that both the foregoing general description and the following detailed description present embodiments of the invention, and are intended to provide an overview or framework for understanding the nature and character of the invention as it is claimed.

The accompanying drawing is included to provide a further understanding of the disclosure, and is incorporated in and constitutes a part of this specification. The drawing illustrates an embodiment of the disclosure, and together with the description serves to explain the principles and operations thereof.

### BRIEF DESCRIPTION OF THE DRAWING

FIG. 1 is a partially broken away side plan view of an apparatus for use as a reaction zone having a gas plasma therein and graphite intercalation compounds passing therethrough to form exfoliated graphite.

FIG. 2 is a front plan view of the apparatus of FIG. 1.

### DETAILED DESCRIPTION

The graphite flakes employed in the present disclosure comprise naturally occurring graphite flakes. Natural graphite is a soft mineral, and possesses a Mohs hardness of 1 to 2, and exhibits perfect basal cleavage. While natural graphite occurs in deposits in different countries around the world in different forms, the preferred natural graphite is crystalline flake graphite, since other types, such as amorphous graphite and so-called “lump” graphite, are considered undesirable for intercalation and exfoliation. Though so-called microcrystalline graphite is not conventionally used in the preparation of exfoliated graphite, it is useful in the process of the present disclosure. Microcrystalline graphite, as is familiar to the skilled artisan, refers to graphite having a microcrystalline structure which can only be observed using x-ray diffraction techniques. While not normally useful in making exfoliated and compressed graphite, a product where graphene layer dimensions are directly related to the useful properties of the product, for nano-structures the layer size of microcrystalline graphite may represent a preferred starting material.

The graphite used in the process of the present disclosure should be relatively free from impurities, meaning it should have a purity of at least about 90%, more preferably at least about 95%. In addition, the size of the graphite flake (by which is meant the diameter of the flake along the a axis, which is the direction parallel to the plane of the flake, or the graphene layers) can be a parameter to be used depending on the end use of the resulting products. For instance, in achieving the production of nano-structures, the flake used advantageously has an average a axis diameter of less than about 100 microns. More preferably, the a axis diameter of the flake employed during the practice of the process of the present disclosure is less than about 60 microns, most preferably less than about 30 microns for products recognizable to the field as “conventional” nanotubes. However, since a desired use of nano-structures such as nano-tubes is adsorption of materials thereon, such as adsorption of hydrogen for hydrogen storage for, e.g., proton exchange membrane fuel cell uses, the number of defect sites may be an important factor since it is believed that adsorption takes place at defect sites. Thus, it is likely that graphene layers of nano-scale thickness and millimeter-scale plane or length dimensions would contain many defects sites, both at its edges and within the plane of the structure, and have many active sites for adsorption to occur, and would therefore have advantageous uses in adsorption applications. For other uses, such as in electronics, larger particles, on the order of about 100 to about 500 microns or even larger, may be desirable.

If desired, the graphite flakes can be annealed prior to intercalation, in order to convert rhombohedral stacking (resulting from mining and upgrading natural graphite ore) to hexagonal, to increase the purity of the flakes and to grow the crystallite size in the plane of the hexagonal array, all of which facilitates intercalation. Annealing involves exposing the raw graphite flakes to high temperatures, on the order of greater than about 2700° C. for anywhere from 15 minutes to one hour and more, as taught, for instance, by U.S. Pat. No. 6,982,874 to Smalc et al.

As noted above, Shane et al., in U.S. Pat. No. 3,404,061, describes a common method for intercalating graphite flakes. Typically, natural graphite flakes are intercalated by dispersing the flakes in a solution containing a mixture of nitric acid and sulfuric acid. The nitric acid and sulfuric acid components of the intercalant solution can be replaced by other acidic compounds, such as potassium chlorate, chromic acid, potassium permanganate, potassium chlorate, potassium dichromate, perchloric acid, or mixtures thereof. Most preferably, the intercalant solution comprises components having a low boiling point and a low heat of vaporization, such as formic acid, acetic acid, or water, or combinations thereof, so that most of the energy of exfoliation results in the greatest expansion of the GICs and, therefore, providing the greatest possible force driving the graphene layers apart.

Intercalation can be so-called spontaneous intercalation (based on the chemical potential of the reagents), or electrochemical (potential) oxidation of the graphite flakes can be practiced during intercalation, as described in U.S. Pat. No. 6,406,612 to Greinke.

However, in one particular embodiment, intercalation is by non-contact intercalation. By “non-contact intercalation” is meant intercalation occurs without direct physical contact between the graphite flake and a liquid intercalant, as contrasted with conventional intercalation methods. Rather, the flakes are contacted with a gaseous or vapor form of the intercalant. More specifically, the vapor evolved from the intercalant, such as fuming nitric acid, contacts the graphite flakes to effect intercalation. In this way, effective intercalation is efficiently effected, while reducing material usage and further reducing the need for disposal and remediation of intercalant materials. In some embodiments, non-contact intercalation is effected by positioning the graphite flakes to be intercalated in a closed container; an intercalant is positioned in the closed container (such as in a smaller (open) container within the closed container), such that fumes from the intercalant contact the graphite flakes.

In non-contact intercalation, the amount of intercalant, especially fuming nitric acid, should be at least about 20% by weight of the weight of the graphite flakes being intercalated; in more preferred embodiments, the amount of intercalant, especially fuming nitric acid, should be at least about 50% by weight of the weight of the graphite flakes being intercalated. In certain embodiments, the closed container is flushed with inert gas to exclude ambient moisture during intercalation.

Non-contact intercalation should continue until the graphite flakes exhibit a weight gain of at least about 10% (thus, assumedly having a 10% take-up of intercalant). In other embodiments, intercalation continues until the graphite flakes exhibit a weight gain of at least about 20%. The time for intercalation will vary with several factors, including thickness of the bed of graphite flakes (with a thinner bed leading to faster intercalation), temperature (with higher temperatures leading to faster intercalation), pressure (with higher pressures leading to faster intercalation), etc. Typically, in room temperature embodiments, intercalation is for a period of at least 30 minutes, more preferably at least one hour. In certain embodiments, intercalation need not be for any longer than 20 hours, and is generally not more than 10 hours. At elevated temperature and pressure, intercalation can take place in seconds and need not be any longer than several minutes (for example, the rate of intercalation is believed to double with every about 7° C. increase in temperature).

Other additives and process parameters can be employed to facilitate intercalation and expansion, such as the use of a supercritical fluid, such as supercritical carbon dioxide, as an intercalant, as described by Kaschak et al. in International Publication No. WO 2004/108997.

As is familiar to the skilled artisan, a supercritical fluid is one which exhibits the properties of a gas when in the liquid state and the properties of a liquid when in the gaseous state. When a gas such as carbon dioxide is contained under high pressure and heated, it changes physical properties, becoming a supercritical fluid. In this state, it has the solvating power of a liquid and the diffusivity of a gas. In short, it has properties of both a gas and a liquid. This means that supercritical fluids work extremely well as a processing media for a wide variety of chemical extractions.

While intercalation with a supercritical fluid can be advantageous for achieving intercalation to the Stage I degree, treatment of the Stage I intercalated flakes with a supercritical fluid like supercritical carbon dioxide can also function to reduce the tendency of the flake to “de-intercalate” to a lower degree of intercalation, and thus a higher Stage of intercalation level (such as from Stage I to Stage V). In addition, treatment of the intercalated flake with a supercritical fluid after completion of intercalation can also improve the expansion of the flake when heated.

While washing with water and hot air drying of the intercalated flake is commonly practiced when sheets of compressed particles of exfoliated graphite are being prepared, washing tends to lower the degree of intercalation of the flake, thus resulting in a flake having a higher Stage of intercalation than prior to washing (going from Stage II to Stage VII, for instance). Since the process of the present disclosure requires expansion of Stage I, II or III GICs, a washing step should be avoided. Rather, if it is desired to remove surface chemicals form the flake which remain after intercalation, drying processes such as centrifugal drying, freeze drying, filter pressing, or the like, can be practiced, to at least partially remove surface chemicals without having a significant negative effect on degree of intercalation.

Once the graphite flakes are intercalated, and, if desired, exposed to a supercritical fluid and/or dried, they are exfoliated. Exfoliation should be effected by suddenly exposing the Stage I, II or III intercalated graphite flakes to high heat. By “suddenly” is meant that the flakes are brought from a temperature at which the selected GIC is stable to a temperature substantially above its decomposition temperature within a period of less than 0.2 second, more preferably less than 0.1 second, and most preferably less than about 0.05 second, to achieve rapid exfoliation. In the preferred embodiment, the extreme heat of a gas plasma and the turbulence which would displace the exfoliate is employed. More preferably, the temperature of exfoliation is at least about 1600° C., and in certain preferred embodiments, the temperature of exfoliation is at least about 1800° C. In other embodiments, the temperature of exfoliation is between about 1600° C. and 3400° C. Since graphene begins to degrade at 2500° C., about 2400° C. is the practical upper limit for exfoliation temperature when graphene particles are sought; when nano-thickness graphite is desired, the upper limit is about 3400° C., since graphite vaporizes at about 3500° C.

During exfoliation, the intercalant inserted between the graphene layers of the graphite (preferably between each graphene layer, as in the case of Stage I intercalation) rapidly vaporizes and literally “blows” the graphene layers apart, with such force that expansion volume levels beyond those typically observed by conventional processing are achieved; in addition, in some embodiments, at least some of the graphene layers separate from the exfoliated flake, and form nano-structures.

Exfoliation can be accomplished in certain embodiments by feeding the GICs, such as Stage I, II or III GICs, into a reaction zone which includes a region where the temperature is at least about 6000° C., such as through the plasma of a plasma torch or the like; of course, this is provided that time for transit through the plasma and exfoliation is controlled such that the graphite intercalation compound does not reach a temperature of greater than 2500° C. In certain embodiments, the reaction zone is at an average temperature of up to about 10,000° C., or even up to about 12,000° C. or higher. As discussed, this can be accomplished by feeding the GICs through an inert gas plasma to provide the high temperature environment needed for greatest expansion. Desirably, exfoliation occurs in a reducing gas environment, such as hydrogen, to adsorb the reducing gas onto active sites on the graphene layers to protect the active sites from contamination during subsequent handling. In addition, in some embodiments, the exfoliate can pass directly into a liquid or liquid vapor suitable to the end use of the exfoliate so that any defect site present can accommodate the chemistry of the end use.

In an embodiment of the present disclosure, thermally separable nano “defects” are formed in the GICs by means of intercalation with volatile compounds. As a result, the layers of the GICs are measurably (using x-ray diffraction) separated by intercalation. The lower the stage number the more the defects, Stage I means every layer is separated by intercalant therefore layers are only angstroms in thickness. Since the plasma environment is inert, exfoliate can be produced with controlled active sites by adding gas to the environment through which the plasma/exfoliate is cooled. For instance, inert (such as argon) oxidizing (such as carbon dioxide), reducing (such as hydrogen) and reactive additives can be employed as additions to the inert cooling environment. Each variation would have different “active sites” and thus behave differently in use.

The exfoliated graphite can be collected by conventional means, such as by centrifugal collectors, and the like and, under certain conditions, such as the solvent into which they are fed, can form individual graphene layers. Contrariwise, the stream of exfoliated/exfoliating GICs as described above can be directed at a suitable support for collection.

Once exfoliation is effected, in some embodiments the exfoliate is fed into a solvent, especially an organic solvent such as N-methyl-2-pyrrolidone (NMP) or tetrachloroethylene, and then sonicated to further break down the exfoliate and/or separate the desired size range particles from others produced during exfoliation. Sonication can be for a period of from about 5 minutes, to 40 hours or longer. Typical sonication periods can be from about 10 minutes to about 90 minutes. The graphite can then be harvested from the solvent by dipping an ultra-flat substrate, such as a silicon wafer, into the solvent and then drying the solvent.

While the precise process is not fully understood, it is anticipated that many of the individual graphene layers, as they separate from the exfoliated flake, or sometime thereafter, will spontaneously assume a three-dimensional shape, such as a buckyball or nano-tube, while the remainder remain as flat plates. Alternatively, the nano-structures may in fact be randomly condensing from carbon vapor. In either case, the separation of individual graphene layers from the GICs during or immediately after exfoliation results in the production of nano-structures. These nano-structures can be produced in large, commercially-significant volumes, and more cost efficiently than convention nano-structure production processes.

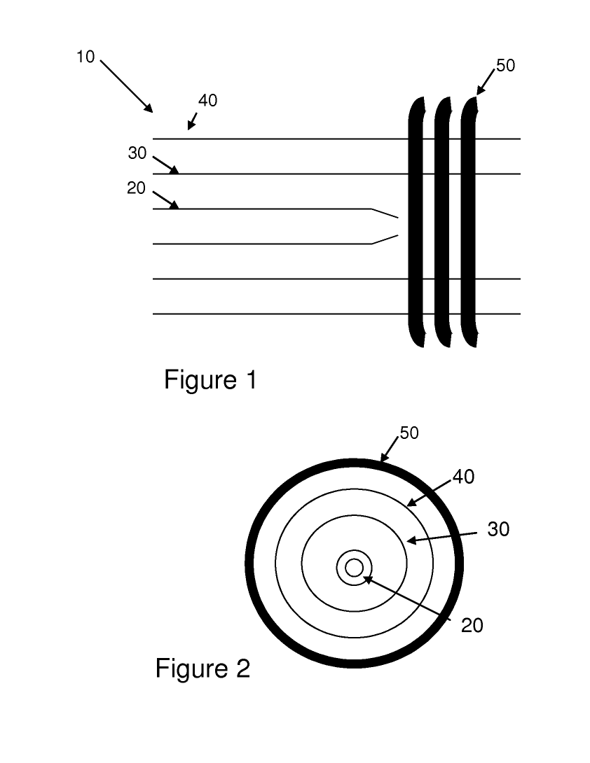

Referring now to FIGS. 1 and 2, a plasma torch 10 which can be used in an embodiment of the disclosure is illustrated. Torch 10 can be the type of plasma torch used in welding/cutting operations, and utilizes an ionized gas, such as ionized argon or helium. Preferably, the ionized gas is then further ionized and coupled to a radio frequency (RF) induction coil typically operating at 26 or 40 MHz. The RF power torches suitable for use in accordance with the present disclosure can vary; in one embodiment, the RF power of one suitable plasma torch can be varied from about 1-2 kilowatts. However, there is no functional upper limit to the power of the torch, and torches in excess of 1 megawatt and higher are available and can be used provided the amount and flow rate of GICs is controlled to ensure the GICs are exposed to the desired temperature ranges (i.e., the GICs are exposed to the temperature of the plasma for the time necessary to ensure the GICs are heated to the desired temperature range). Plasma torch 10 comprises three concentric tubes, the walls of which are denoted 20, 30 and 40. Center tube 20 is the GIC injector, the middle tube 30 provides auxiliary gas flow shaping the injected charge, and outer tube 40 is the plasma. In some embodiments, the material supplied through the respective tubes varies, such as providing the plasma gas through middle tube 30 and the auxiliary gas through outer tube 40; in certain circumstances, this might be preferred. Ionization of the plasma gas is effected by induction coil 50.

An injector (not shown) is provided for feeding GICs can be the barrel of an extruder or a nebulizer (spray) to feed intercalated flake/intercalant in order to help assure than Stage I GICs are fed into the plasma. In fact, any feeder capable of feeding the GICs in the required manner is suitable for use herein. This is especially so in those embodiments in which the flake is “wet” from the intercalation process. In yet another embodiment, it may be useful to freeze the GICs, such as bringing the GICs to a temperature of less than −50° C., or even less than −100° C.; indeed, it may be useful to freeze the GICs to a temperature of less than −150° C. After freezing, the frozen mass is crushed to make it easier to feed the particles through a refrigerated feeder.

The injector flow for injector 50 is, in certain embodiments, about 250 to 3000 ml/min on average; in another embodiment, the injector flow is about 500 to 200 ml/min. Again, the specific flow of GICs can be varied depending on the power of the torch being used.

The plasma exiting the torch is restored to the parent inert gas. With design, the environment can be controlled. Greatly exfoliated graphite results in nano thickness arrays and even graphene (mono layer) hexagonal arrays. The product produced can be distributed through classifiers to separate them, based on density, size or weight, and collected in cyclones as exfoliate or, in appropriately designed devices, captured and condensed in the media required for use.

The following examples are provided to illustrate some embodiments of the present disclosure but should not be interpreted as any limitation thereon. Other embodiments within the scope of the claims herein will be apparent to one skilled in the art from the consideration of the specification or practice of the methods disclosed herein. It is intended that the specification, together with the examples, be considered to be exemplary only, with the scope and spirit of the disclosure being indicated by the claims which follow the examples.

The experimental device is an inductively coupled plasma torch. The device does not require a “ground”, debris from which would contaminate the end product. The torch consists of three concentric tubes of ˜0.6, 2 and 2.5 cm outside diameters. Intercalated graphite flake is carried through the center tube by an inert gas stream (argon) by a flow volume 0.5 to 2 liters per minute. Velocity through the plasma is based upon the inner diameter of the tube which can be varied from 0.25 to 0.5 cm. The surrounding tube provides the plasma gas (20.0 liters per minute argon gas), which is ionized to start by means of a Tesla coil. The plasma gas is then further ionized and stimulated to a plasma temperature of 6000° C. to 8000° C. by means of 1.3 to 2.5 kW of power from a 40 MHz induction coil. The plasma envelops the intercalated graphite flake over about 3 cm of length. Depending upon flow of the intercalated graphite flake and the inner diameter of the center tube, the residence time of the intercalated graphite flake within the plasma has ranged from 5 to 80 milliseconds. The outer tube is a protective shield consisting of inert gas and/or reactive gas at a total flow volume of 1 to 3 liters per minute.

### Example 1

The intercalated graphite used is commercially obtained and is a residue compound, intercalated to stage 7-20. One gram per minute of intercalated graphite is carried into the plasma through a 0.3 cm inside diameter center tube. Residence time in the hot zone is approximately 5 milliseconds. Exfoliate is fed into NMP and prepared for SEM, and product of 10 to 50 nm thickness is observed.

### Example 2

Highly oriented graphite is intercalated by non-contact intercalation using equal weights of graphite and 98%+ fuming nitric acid. The flake and adjacent container of acid are reacted in a sealed container. One gram per minute of intercalated graphite is carried into the plasma through a 0.3 cm inside diameter center tube. Residence time in the hot zone is approximately 5 milliseconds. Exfoliate is fed into NMP and prepared for SEM, and product of thickness less than 5 nanometers is observed.

### Example 3

Highly oriented graphite is intercalated by non-contact intercalation using one part graphite by weight and 1.5 parts of 98%+ fuming nitric acid. The flake and adjacent container of acid are reacted in a sealed container. One gram per minute of intercalated graphite is carried into the plasma through a 0.3 cm inside diameter center tube. Residence time in the hot zone is approximately 5 milliseconds. Exfoliate is fed into NMP and prepared for SEM, and product of thickness less than 5 nanometers is observed. Some graphene is noted (about 4 angstroms in thickness).

### Example 4

Highly oriented graphite was intercalated by non-contact intercalation using equal weight of graphite and 98%+ fuming nitric acid and 0.1 weight of 99% fuming sulfuric acid. The flake and adjacent containers of acid are reacted in a sealed container. One gram per minute of intercalated graphite is carried into the plasma through a 0.3 cm inside diameter center tube. Residence time in the hot zone is approximately 5 milliseconds. Exfoliate is fed into NMP and prepared for SEM, and product of thickness less than 3 nanometers is observed. Some graphene is noted (about 4 angstroms in thickness).

By the practice of the present disclosure, exfoliation volumes can be achieved which are at least 2 times, and can be 3 or more times that which can be achieved using the same GICs, but exfoliated conventionally. In addition, post processing treatment can also result in the production of nano-structures in commercially reasonable quantities.

All patents and patent applications referred to herein are hereby incorporated by reference.

It will be apparent to those skilled in the art that various modifications and variations can be made to the present disclosure without departing from the spirit and scope of the disclosure. It is intended that all such modifications and variations are part of the present disclosure provided they come within the scope of the foregoing claims, and their equivalents.

What is claimed is:

1. A process for the production of exfoliated graphite, comprising providing a graphite intercalation compound; and exfoliating the graphite intercalation compound by passing the graphite intercalation compound through a plasma which is at a temperature of at least about 6000° C. to bring the graphite intercalation compound to a temperature between about 1600° C. and about 3400° C.

2. The process of claim 1, wherein graphite intercalation compound is brought to a temperature between about 1600° C. and about 2400° C.

3. The process of claim 1, wherein the graphite flake is intercalated with an intercalant comprising formic acid, acetic acid, water, or combinations thereof.

4. The process of claim 1, wherein the graphite intercalation compound is intercalated to Stage I, II or III intercalation.

5. The process of claim 1, wherein the graphite intercalation compound is brought from a temperature at which it is stable to a temperature between 1600° C. and 3400° C. within a period of no more than about 0.2 second.

6. The process of claim 5, wherein the graphite intercalation compound is brought from a temperature at which it is stable to a temperature between 1600° C. and 3400° C. within a period of no more than about 0.05 second.

7. The process of claim 1, wherein exfoliation occurs in a reducing gas environment.

8. The process of claim 7, wherein exfoliation occurs in a hydrogen environment.

9. The process of claim 1, wherein a plurality of individual grapheme layers are separated from the exfoliated graphite.

10. The process of claim 9, wherein at least some of the plurality of individual graphene layers spontaneously form a nano-tube or a Buckminster fullerene.
